(19) United States
(12) Patent Application Publication
(10) Pub. No.: US 2015/0187340 A1
(43) Pub. Date: Jul. 2, 2015

(54) INFORMATION PROCESSING APPARATUS AND METHOD FOR CONTROLLING INFORMATION PROCESSING APPARATUS

(71) Applicant: CANON KABUSHIKI KAISHA, Tokyo (JP)

(72) Inventor: Manabu Ozawa, Kawasaki-shi (JP)

(21) Appl. No.: 14/580,116

(22) Filed: Dec. 22, 2014

(30) Foreign Application Priority Data
Dec. 27, 2013 (JP) 2013-272037

(51) Int. Cl. G09G 5/393

(52) U.S. Cl. CPC G09G 5/393; G09G 2330/022; G09G 2360/08

(57) ABSTRACT

An information processing apparatus including a display unit that performs a panel self-refresh operation and displays an operation screen identifies, when a content of an operation screen displayed on the display unit is to be changed, a type of operation screen to be displayed after change of the content, and determines whether display unit is to perform the panel self-refresh operation according to the identified type of operation screen after the change.

### BACKGROUND

1. Field

Aspects of the present invention generally relate to an information processing apparatus having a display unit.

2. Description of the Related Art

An information processing apparatus, such as a multifunction peripheral (MFP), has a large-sized display device. However, an increase in size of the display device may increase a load on the generation and display control of screen data to be displayed on the display device. This may cause an increase in the power consumption of the information processing apparatus. In particular, a liquid crystal display (LCD), which is widely used as the display device, has a characteristic that even in the case of still image display, the screen needs to be kept updated at a fixed rate to maintain the content of the display. Therefore, screen data generation and screen data transfer processing need to be performed at fixed intervals. This has been a barrier to the reduction in the power consumption.

In view of such a background, Japanese Patent Application Laid-Open No. 2013-161089 discusses a technique called panel self refresh (PSR) which aims to reduce the power consumption required for display. PSR has been standardized in conformance with embedded Display Port 1.3 (eDP1.3) (trademark) by Video Electronics Standards Association (VESA) (trademark).

A display device conforming to the panel self refresh technique includes a timing controller having an image buffer. Further, the display device compares a plurality of frames of screen data supplied to the display device, and, when there is no change, issues to the timing controller an instruction for shifting to the panel self refresh, and stores the screen data in the image buffer. Then, the display device shifts to a state in which the screen is updated by using the screen data stored in the image buffer. This can reduce the frequency at which a main controller (for supplying screen data to the display device) generates the screen data and transmits it to the display device, thereby decreasing the power consumed for image control by the entire information processing apparatus.

On an operation screen employed by embedded apparatuses including an information processing apparatus, such as an MFP, a user performs an operation, for example, by selecting a desired function on a still image screen in which buttons are arranged. Such an operation screen seldom changes the display content, and therefore can fully take advantage of a power saving effect of the panel self refresh. However, in conventional panel self refresh control, a plurality of frames is kept compared for the presence or absence of changes so as to monitor whether there is a screen change. In the conventional panel refresh control, computer resources are operated to monitor whether there is a screen change, and therefore the power consumption for the operation cannot be reduced.

### SUMMARY

Aspects of the present invention are generally directed to a technique for performing panel self refresh control which can facilitate the reduction of power consumption of an information processing apparatus.

According to an aspect of the present invention, an information processing apparatus includes a display unit configured to perform a panel self-refresh operation and to display an operation screen, an identification unit configured to, when a content of the operation screen displayed on the display unit is to be changed, identify a type of operation screen to be displayed after change of the content, a determination unit configured to, according to the type of operation screen after the change identified by the identification unit, determine whether the display unit is to perform the panel self-refresh operation, and a control unit configured to, when the determination unit determines the display unit is to perform the panel self-refresh operation, control the display unit to perform the panel self-refresh operation.

Further features will become apparent from the following description of exemplary embodiments with reference to the attached drawings.

### BRIEF DESCRIPTION OF THE DRAWINGS

FIG. 1 illustrates an example of a hardware configuration of an MFP according to a first exemplary embodiment.

FIG. 2 illustrates details of a configuration of an operation unit according to the first exemplary embodiment.

FIGS. 3A, 3B, and 3C each illustrate an example of an operation screen displayed on an operation unit of the MFP according to the first exemplary embodiment.

FIG. 4 illustrates an example of a table indicating an operation frequency of each operation screen according to the first exemplary embodiment.

FIG. 5, which consists of 5A and 5B, is a flowchart illustrating panel self refresh control processing according to the first exemplary embodiment.

FIG. 6 illustrates a part of a hardware configuration of an MFP according to a second exemplary embodiment.

FIGS. 7A, 7B, and 7C each illustrate an example of a management table according to the second exemplary embodiment.

FIG. 8 is a flowchart illustrating panel self refresh control processing according to the second exemplary embodiment.

FIGS. 9A, 9B, and 9C each illustrate an example of a copy setting screen displayed on an operation unit of an MFP according to a third exemplary embodiment.

FIG. 10 is a flowchart illustrating panel self refresh control processing according to the third exemplary embodiment.

### DESCRIPTION OF THE EMBODIMENTS

Various exemplary embodiments, features, and aspects will be described in detail below with reference to the drawings. As an example of an information processing apparatus according to an exemplary embodiment, an MFP (digital multifunction peripheral) will be described below. The MFP is provided with a plurality of functions of a scanner, a printer, and a copying machine, and has a touch panel screen employing a display device capable of performing the panel self refresh operation. However, while application of an exemplary embodiment is directed to an MFP, other exemplary embodiments can be directed all types of information processing apparatuses having a display device for displaying operation screens.

A first exemplary embodiment will be described below using an MFP which is provided with a plurality of functions of a scanner, a printer, and a copying machine, and has a multi-touch detectable touch panel employing a display device capable of performing the panel self refresh operation.

### <Configuration of MFP>

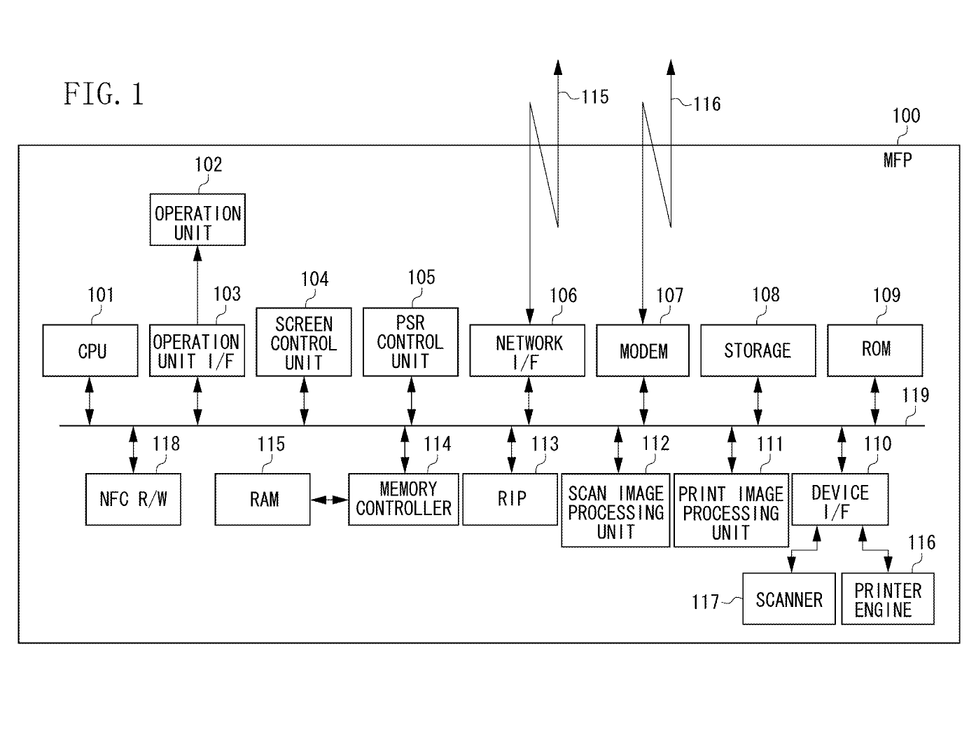

FIG. 1 illustrates an example of a hardware configuration of an MFP which is an example of an information processing apparatus according to the present exemplary embodiment. Referring to FIG. 1, a scanner 117, which serves as an image input device, and a printer engine 116, which serves as an image output device, are connected to an MFP 100 via a device interface (device I/F) 110. The scanner 117 reads document image data. The printer engine 116 outputs a printed sheet. The MFP 100 connects to a local area network (LAN) 115 via a network interface (network I/F) 106, and connects to a public line 116 via a modem 107.

A central processing unit (CPU) 101 comprehensively controls the MFP 100. The CPU 101 also controls a PSR control unit 105 of the MFP 100 to enable or disable the panel self refresh operation. When the CPU 101 determines to update a display content of a screen upon reception of an input from an operation unit interface (operation unit I/F) 103 (described below) of the MFP 100, the CPU 101 can instruct a screen control unit 104 (described below) to update the display content. Although a single CPU 101 executes each step illustrated in flowcharts (described below) by using a single memory, i.e., a random access memory (RAM) 115, the configuration is not limited thereto. For example, it is also possible that a plurality of CPUs and a plurality of RAMs operate in collaboration to execute each step of the flowcharts.

An operation unit 102 receives an operation instruction from an operator, and displays a result of the operation. The operation unit 102 includes one or more display devices capable of performing the panel self refresh operation. Although the display device according to the present exemplary embodiment includes a liquid crystal display having a touch panel, other types of display devices requiring a refresh operation may be used. The operation unit 102 may also include various mechanical switches, such as a power switch and a keyboard. The operation unit 102 further converts an input signal input to the operation unit 102 through a user operation into a format executable by the MFP 100, and then transmits the signal to the CPU 101.

The operation unit I/F 103 is a communication interface disposed between the operation unit 102 and the MFP 100. The operation unit I/F 103 is provided with image communication and control protocols conforming to the eDP1.3 standard or later. The operation unit I/F 103 also serves as an interface for transmitting an input signal input to the operation unit 102 through a user operation to the MFP 100.

The screen control unit 104 transfers the screen data stored in the image buffer to a display control unit 205 (described below) via the operation unit I/F 103 and a display input/output I/F 208 (described below) at a timing determined by the system.

The PSR control unit 105 performs control to enable or disable the panel self refresh operation. The PSR control unit 105 may store status information indicating whether the panel self refresh operation is enabled or disabled. The panel self refresh operation is enabled, for example, at a timing when the CPU 101 issues an instruction for enabling or disabling the panel self refresh operation to the PSR control unit 105. However, for example, the PSR control unit 105 may be configured to operate in response to receiving a signal from the screen control unit 104 when the screen control unit 104 is controlled to perform a screen transition. The panel self refresh operation is enabled by controlling the display control unit 205 (described below) by using a protocol defined by eDP1.3 or later.

The network I/F 106, which is implemented by a LAN card, for example, connects to the LAN 115, and outputs and inputs device information and image data to/from an external apparatus.

The modem 107 connects to the public line 116, and outputs and inputs control information and image data to/from an external apparatus.

A storage 108 is a mass storage device represented by a hard disk drive and a solid state drive (SSD), and stores programs for various processing and input image data.

A read only memory (ROM) 109 is a boot ROM and stores the boot program of the system. The device I/F 110 connects to the scanner 117 and the printer engine 116, and performs image data transfer processing.

A print image processing unit 111 performs image correction processing on image data to be printed out, according to the state of the printer engine 116.

A scan image processing unit 112 performs various processing on image data read by the scanner 117. More specifically, the scan image processing unit 112 corrects, processes, and edits the image data.

A raster image processor (RIP) 113 rasterizes page description language (PDL) codes included in print data received via the network I/F 106 into image data.

A memory controller 114 converts, for example, a memory access command from the CPU 101 or each image processing unit into a command interpretable by the RAM 115, and accesses the RAM 115.

The RAM 115 serves not only as a system work memory for the CPU 101 to operate but also as an image memory for temporarily storing input image data and storing image data for image editing. The RAM 115 also stores setting data used for print jobs. The RAM 115 is also used as an image drawing buffer for storing an image to be displayed on the operation unit 102.

A near field communication (NFC) reader writer (NFC R/W) 118 is an interface for implementing short-distance wireless communication, and is utilized for user authentication using a noncontact integrated circuit (IC) card. The above-described units are arranged on a system bus 119.

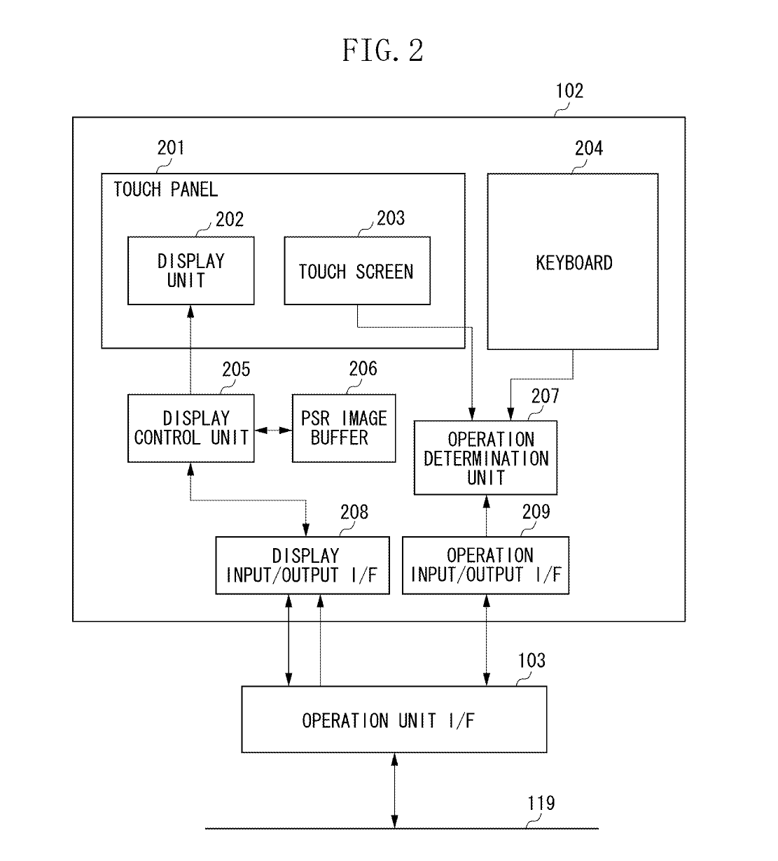

FIG. 2 illustrates details of a configuration of the operation unit 102 according to the present exemplary embodiment.

A touch panel 201 displays an operation screen of the MFP 100 and a preview image, and receives an input of a touch operation performed by the operator.

The touch panel 201 is composed of a display unit 202 and a touch screen 203 stacked together.

The display unit 202 is a display device represented by an LCD. An image obtained when the CPU 101 combines text and graphics is stored in the image buffer. Then, the image is sent to the display control unit 205 at a predetermined drawing timing, and is displayed on the display unit 202. The image buffer itself may be a part of a storage area in the above-described RAM 115, or provided as a separate memory (not illustrated) dedicated for use as an image buffer.

The touch screen 203 is stacked on top of the display unit 202. When the operator performs a touch operation on the touch panel 201, the touch screen 203 detects the touch operation and outputs an input signal to an operation determination unit 207. The touch screen 203 according to the present exemplary embodiment is a projection capacitance type multi-touch screen capable of detecting a plurality of positions that is simultaneously touched. A different type of touch screen may be used as the touch screen 203. For example, instead of stacking the touch screen 203 on top of the display unit 202, the touch screen 203 may be integrated with the display screen 202.

A keyboard 204 is attached to the operation unit 102 to allow the operator to input numerical values. However, functions executable by the keyboard 204 may be built in a touch user interface (UI). In this case, the keyboard 204 may be removed from the operation unit 102.

The display control unit 205 is included in the operation unit 102. The display control unit 205 performs control to transfer the image data transferred via the display input/output I/F 208 (described below) to the display unit 202 at a desired timing to display an image on the display unit 202. Upon reception of an instruction from the PSR control unit 105, the display control unit 205 performs panel self refresh control. At this timing, the display control unit 205 switches a source of display image data from the display input/output I/F 208 to a PSR image buffer 206 (described below). Then, the display control unit 205 performs control to display the image data stored in the PSR image buffer 206 on the display unit 202. The display control unit 205 includes a register for control setting and a status register indicating the operating status.

The PSR image buffer 206 is a temporary memory for storing the content to be displayed on the display unit 202 when performing the panel self refresh operation. Writing of an image to the PSR image buffer 206 is performed according to a method and timing defined by eDP1.3 or later.

The operation determination unit 207 converts an input from the touch screen 203 and the keyboard 204 into a format recognizable by the CPU 101, and then transfers it to the CPU 101. The transfer to the CPU 101 may be performed each time an operation on the touch screen 203 or the keyboard 204 is received, performed at a predetermined timing, or performed in response to a send request issued from the CPU 101 to the operation determination unit 207 at a predetermined timing.

The display input/output I/F 208 connects to the display control unit 205 and the system bus 119 via the operation unit I/F 103 provided on the MFP 100, and suitably inputs image data from the system bus 119 to the display control unit 205. Further, conforming to a protocol defined by eDP1.3 or later, the display input/output I/F 208 also operates as an input/output I/F for control signals used to perform status check and PSR control between the display control unit 205 and the PSR control unit 105. Further, circuit blocks used to transfer image data in the display input/output I/F 208 and the operation unit I/F 103 are configured to interrupt the power supply when the panel self refresh operation is enabled. In this case, a method for freely controlling the power supply to a part of the circuit, such as a power gate, is used. More specifically, the apparatus is configured to perform control for interrupting the power supply to the blocks related to image data transfer in the display input/output I/F 208 and the operation unit I/F 103 when the panel self refresh operation is enabled.

An operation input/output I/F 209 is an interface for transmitting, via the operation unit I/F 103, the data obtained when the operation determination unit 207 converts input data, to the system bus 119 to which the CPU 101 is connected.

### <Examples of Operation Screens and Features of Screen Transition>

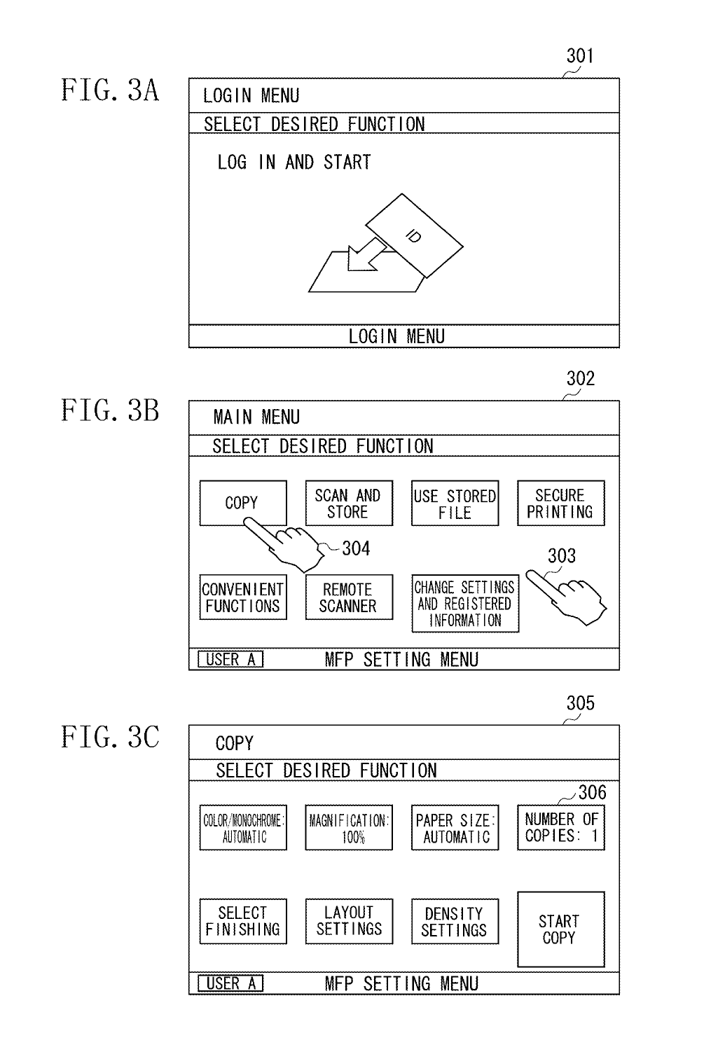

FIGS. 3A, 3B, and 3C illustrate examples of operation screens displayed on the operation unit 102 of the MFP 100 according to the present exemplary embodiment. As examples of the operation screens, FIGS. 3A, 3B, and 3C illustrate a login screen 301, a function selection screen 302, and a copy setting screen 305, respectively. The login screen 301 includes only still images, not including moving image elements. The login screen 301 is always displayed before a new user starts an operation of the MFP 100. To start using the MFP 100, the user performs a login operation, for example, by loading an authentication ID card into a card reader such as the NFC R/W 118 provided in the MFP 100. In the present exemplary embodiment, when the user performs the login operation, the operation screen changes from the login screen 301 to the function selection screen 302.

The function selection screen 302 displays functions available on the MFP 100. More specifically, function button icons are arranged on the function selection screen 302, for example. The user presses a desired function button to select the function. When the user selects a function on this screen, the screen changes to a more detailed setting screen related to the selected function. For example, when the user touches a button icon corresponding to a copy function, as illustrated by an operation 304, the screen changes to the copy setting screen 305. When the user touches a position other than the button icons, as illustrated by an operation 303, a screen transition does not occur. While the user performs no operation, the function selection screen 302 according to the present exemplary embodiment displays a still image in which buttons are simply arranged.

The copy setting screen 305 displays a plurality of copy function setting items including a color/monochrome setting, a magnification setting, a paper size setting, and the number of copies. When the user selects a desired setting and then presses the “START COPY” button, the MFP 100 starts the copy operation. While the user performs no setting operation, the copy setting screen 305 according to the present exemplary embodiment also displays a still image in which buttons are simply arranged.

As described above, the MFP 100 changes the display content of the operation screen in response to a certain action performed on the operation unit 102 by the user. Then, the MFP 100 uniquely fixes the screen after the screen transition.

### <Operation Frequency Table>

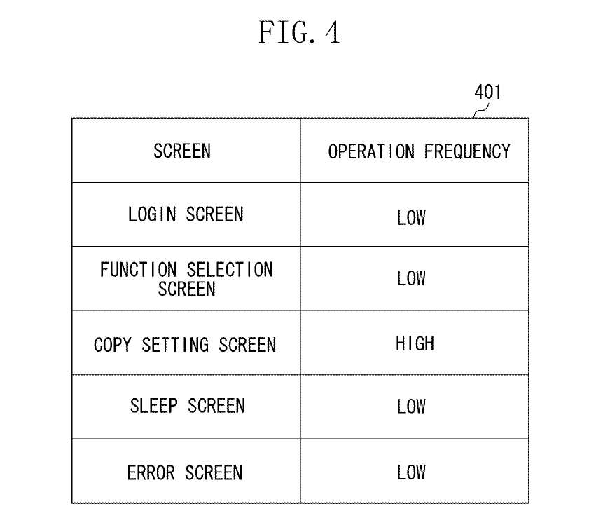

FIG. 4 illustrates an example of an operation frequency table 401 indicating the operation frequency of each operation screen according to the present exemplary embodiment. The operation frequency table 401 is a list of respective operation frequencies corresponding to operation screens displayed on the operation unit 102, and is preset in the present exemplary embodiment.

For example, as described above with reference to FIG. 3A, the login screen 301 is displayed until the next user performs the login operation. More specifically, the login screen 301 continues to be displayed from when a certain user logs out until when the next user logs in. Since the user operation frequency is very low, the operation frequency is set to “LOW”.

On the other hand, as described above with reference to FIG. 3C, the copy setting screen 305 is used by the user to input desired operation settings. Therefore, the user operation frequency is high. For example, when performing a setting to increase the number of copies by using a number-of-copies setting button 306, the user keeps pressing the button until the desired number of copies is reached. Therefore, the operation frequency of the copy setting screen 305 is set to “HIGH”. The contents of operation screens are changed by user operations in many cases. Therefore, the contents of operation screens having a high operation frequency are frequently changed. On the other hand, the contents of operation screens having a low operation frequency are not frequently changed.

Thus, by storing the user operation frequency in each screen in an associated manner, as illustrated in the operation frequency table 401, the CPU 101 can acquire the operation frequency of the next screen at the time of screen transition. This operation frequency information is used by the CPU 101 to determine whether the panel self refresh operation is to be enabled or disabled after a screen transition. Although, in the present exemplary embodiment, the operation frequency information is predetermined, it is also possible to record user operation frequencies and change the operation frequency information in the operation frequency table 401 based on the recorded operation frequencies.

The operation frequency table 401 is stored in the storage 108 of the MFP 100. As long as the information in the operation frequency table 401 remains unchanged, the operation frequency table 401 may be stored in the ROM 109.

### <Flow of Panel Self Refresh Control>

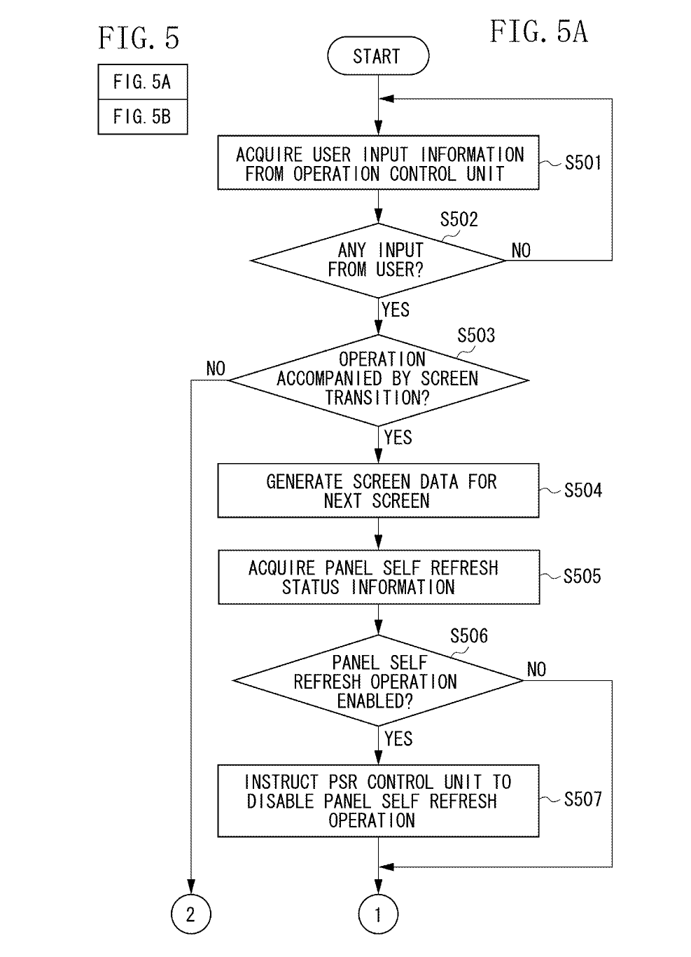

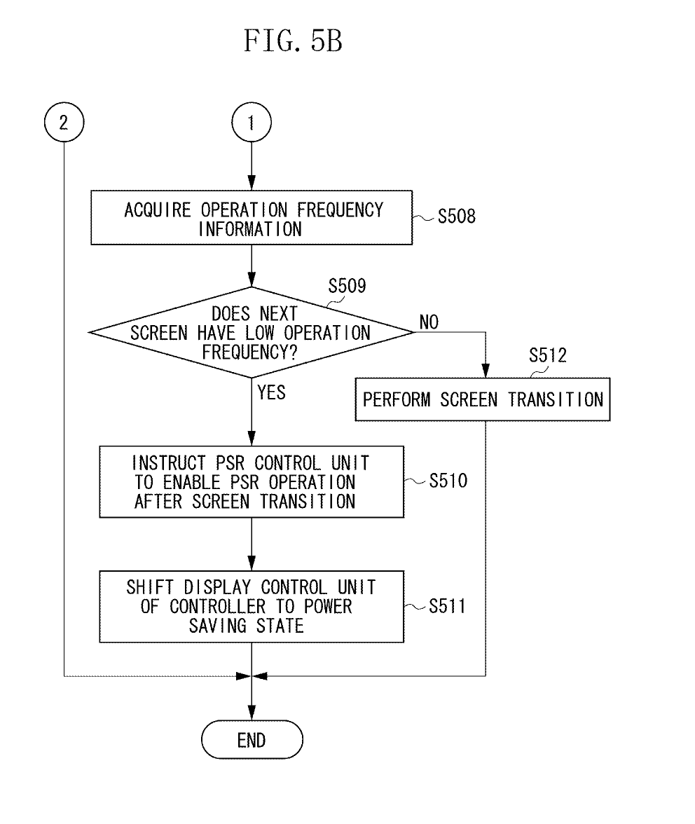

FIG. 5 is a flowchart illustrating panel self refresh control processing according to the present exemplary embodiment. Although the flowchart will be described below on the assumption that the initial state of the display system is the panel self refresh state, the initial state is not limited to the panel self refresh state. The flowchart illustrated in FIG. 5 is executed by the CPU 101 of the MFP 100.

In step S501, the CPU 101 acquires operation input information received by the operation determination unit 207. The operation input information includes, for example, the presence or absence of an operation input to the operation unit 102 by the user, an input method (a keyboard operation or a touch panel operation), and input coordinates (in the case of a touch panel operation). The operation input information may also include the type of touch panel operation (tap or flick). For example, the operation 304 performed on the above-described function selection screen 302 illustrated in FIG. 3 is determined to be a touch panel input, and the operation determination unit 207 acquires coordinate data of a position touched by the finger on the touch screen 203, and coverts the data into a format required by the CPU 101. Two methods can be used for acquiring the operation input information. In one method, when an operation is input to the operation unit 102, an interruption is issued and the CPU 101 performs control to read information. In the other method, the CPU 101 performs control to periodically check the operation unit 102 for the presence or absence of an operation input.

In step S502, based on the operation input information acquired in step S501, the CPU 101 extracts the presence or absence of an input from the user to determine whether a user operation has been performed on the operation unit 102. When a user operation is determined to have been performed (YES in step S502), the processing proceeds to step S503. On the other hand, when a user operation is determined to have not been performed (NO in step S502), the processing returns to step S501.

In step S503, based on the operation input information acquired by the CPU 101 in step S501, the CPU 101 determines whether the operation performed is accompanied by a screen transition. When the operation is determined to be not accompanied by a screen transition (NO in step S503), the processing exits this flowchart and returns to the starting point. When the operation is determined to be accompanied by a screen transition (YES in step S503), the processing proceeds to step S504. Herein, the operation accompanied by a screen transition refers to a login operation using an authentication ID card, an operation for returning from the sleep state to the normal mode, and other operations in which the content displayed on the screen changes. In the present exemplary embodiment, an example will be described below on the assumption that the CPU 101 determines whether a button accompanied by a screen transition is pressed, based on the input coordinates of a touch panel input and the coordinates of a screen transition area for causing a screen transition. The screen transition area refers to an area where the function buttons illustrated in FIG. 3 are displayed. In the above-described operation 303 in the function selection screen 302, the user touches a screen area other than the icon buttons. In this case, the operation 303 provides input coordinates indicating the outside of the screen transition area, and therefore the CPU 101 determines that no icon button is pressed. On the other hand, the operation 304 provides input coordinates indicating the inside of the screen transition area, and therefore the CPU 101 determines that an icon button is pressed. Although a determination method for the touch panel has been described above, it is also possible to determine the transition to a screen related to a pressed mechanical switch.

In step S504, the CPU 101 generates screen data for a transition destination screen according to the operation accompanied by a screen transition determined in step S503, and stores the data in the image buffer. Hereinafter, the description will be made on the assumption that the RAM 115 is used as the image buffer.

In step S505, the CPU 101 acquires panel self refresh status information. The panel self refresh status information includes information indicating whether the panel self refresh operation is currently enabled or disabled. The panel self refresh status information may be retained by the PSR control unit 105, stored in the RAM 115, or retained by the display control unit 205.

In step S506, based on the self refresh status information acquired in step S505, the CPU 101 determines whether the operation unit 102 is in the panel self refresh state. When the operation unit 102 is determined to be in the self refresh state (YES in step S506), the processing proceeds to step S507. On the other hand, when the operation unit 102 is determined to be not in the self refresh state (NO in step S506), the processing proceeds to step S508.

In step S507, the CPU 101 instructs the PSR control unit 105 to cancel the panel self refresh operation. Upon reception of the instruction from the CPU 101, the PSR control unit 105 transmits a PSR cancellation instruction for disabling the panel self refresh operation to the display control unit 205.

In step S508, the CPU 101 acquires the operation frequency information for the next transition destination screen from the screen operation frequency information described in FIG. 4. For example, when the user performs the operation 304, i.e., when the user touches the COPY button icon in the function selection screen 302 illustrated in FIG. 3, the CPU 101 acquires the operation frequency information for the copy setting screen 305. In this case, the CPU 101 acquires information indicating that the operation frequency is “HIGH”. Further, when a screen transition due to a partly changed setting, such as a numerical value, on the same screen occurs, the CPU 101 acquires the operation frequency information for the same screen. For example, on the copy setting screen 305 illustrated in FIG. 3, a screen transition occurs intermittently to reflect, in the display, a change in the numerical value due to, for example, an operation of the number-of-copies setting button 306. Therefore, the CPU 101 acquires the operation frequency information for the copy setting screen 305 as the operation frequency information for the next screen.

In step S509, based on the operation frequency information acquired in step S508, the CPU 101 determines whether the next transition destination screen has a low operation frequency. When the next screen is determined to have a low operation frequency (YES in step S509), the processing proceeds to step S510. On the other hand, when the next screen is determined to have a high operation frequency (NO in step S509), the processing proceeds to step S512.

In step S510, the CPU 101 instructs the screen control unit 104 and the PSR control unit 105 to read the screen data for the next screen generated in step S504 from the image buffer, transmit the data to the display control unit 205, and enable the panel self refresh operation. This allows the operation unit 102 to perform the panel self refresh operation after the display transition, reducing the power consumption of the MFP 100. Further, executing the operations in steps S507 to S510 in a time as short as possible increases the effect of power saving achieved by executing this flowchart.

In step S511, the CPU 101 performs control to interrupt the power supply to the screen control unit 104, and the screen data transfer related portion in the display input/output I/F 208 and the operation unit I/F 103 as described above.

In step S512, since the next screen is determined to have a high screen transition frequency in step S510, the CPU 101 performs control to instruct the screen control unit 104 to read the screen data for the next screen generated in step S504 from the image buffer and then transmit the data to the display control unit 205. In this case, the CPU 101 does not enable the panel self refresh operation.

As described above, in the present exemplary embodiment, the CPU 101 acquires the operation frequency information for the next screen at the time of screen transition, and, only when the operation frequency is determined to be low, performs control to enable the panel self refresh operation after the screen transition, thereby ensuring a longer panel self refresh period. Accordingly, the power consumption required to display operation screens can be reduced.

In the above-described first exemplary embodiment, while focusing on the case where the user operates the operation unit 102 and the operation causes a screen transition, when an operation screen as the transition destination has a “LOW” operation frequency, the CPU 101 performs control to enable the panel self refresh operation after the screen transition.

In the second exemplary embodiment, when the MFP 100 changes the operation mode based on the result of detection by a sensor, the CPU 101 determines whether to enable or disable the panel self refresh operation, based on the screen transition frequency of the operation unit 102 according to the operation mode after the change.

### <Configuration of MFP According to Second Exemplary Embodiment>

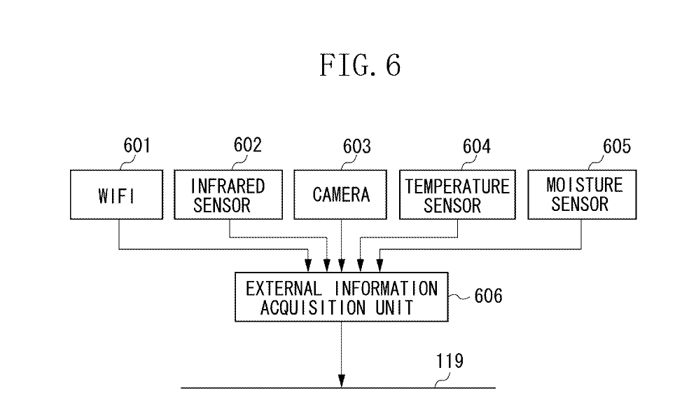

The MFP 100 according to the second exemplary embodiment, a sensor group illustrated in FIG. 6 is further added to the hardware configuration of the MFP 100 illustrated in FIG. 1. The other portion of the hardware configuration is similar to that illustrated in FIG. 1.

Details of the configuration of the operation unit 102 of the MFP 100 according to the second exemplary embodiment are as illustrated in FIG. 2. Image data is displayed on the display unit 202 of the operation unit 102 of the MFP 100.

Similarly to the first exemplary embodiment, the MFP 100 according to the second exemplary embodiment displays the operation screens illustrated in FIG. 3 according to the first exemplary embodiment. A table which is similar to the operation frequency table 401 illustrated in FIG. 4 according to the first exemplary embodiment is stored in the storage 108 (or the ROM 109) of the MFP 100 according to the second exemplary embodiment.

FIG. 6 illustrates a part of the hardware configuration of the MFP 100 according to the second exemplary embodiment. Referring to FIG. 6, a camera 603 and a temperature sensor 604 are connected to an external information acquisition unit 606. The external information acquisition unit 606 is connected to the system bus 119 illustrated in FIG. 1. Sensors other than the ones illustrated in FIG. 6 may be provided, and each of the sensors may be used for the purpose other than the one described below. Each of the sensors may be directly connected to the system bus 119.

The camera 603 can detect four different states: a state where the user approaches the MFP 100, a state where the user is near the MFP 100, a state where the user moves away from the MFP 100, and a state where the user is not near the MFP 100. Although, in the present exemplary embodiment, the existence of a user around the MFP 100 is detected by the camera 603, a sensor other than the camera 603 may be used. For example, a wireless communication (such as Wi-Fi 601) interface may be connected to the external information acquisition unit 606 to measure the distance to a communication partner apparatus and further the distance to a user having the communication partner apparatus, based on the intensity of radio wave from the communication partner apparatus. For example, an infrared sensor 602 may be connected to the external information acquisition unit 606 to determine whether a user is around the MFP 100, based on the intensity of the infrared radiation which irradiates the sensing area of the sensor.

The temperature sensor 604 is used to measure the temperature inside the MFP 100. The temperature sensor 604 is used to determine that the MFP 100 is in an error condition when the temperature inside the MFP 100 exceeds a predetermined temperature. The CPU 101 of the MFP 100 provided with the above-described sensors periodically acquires sensor information, and changes its operation mode based on the acquired information.

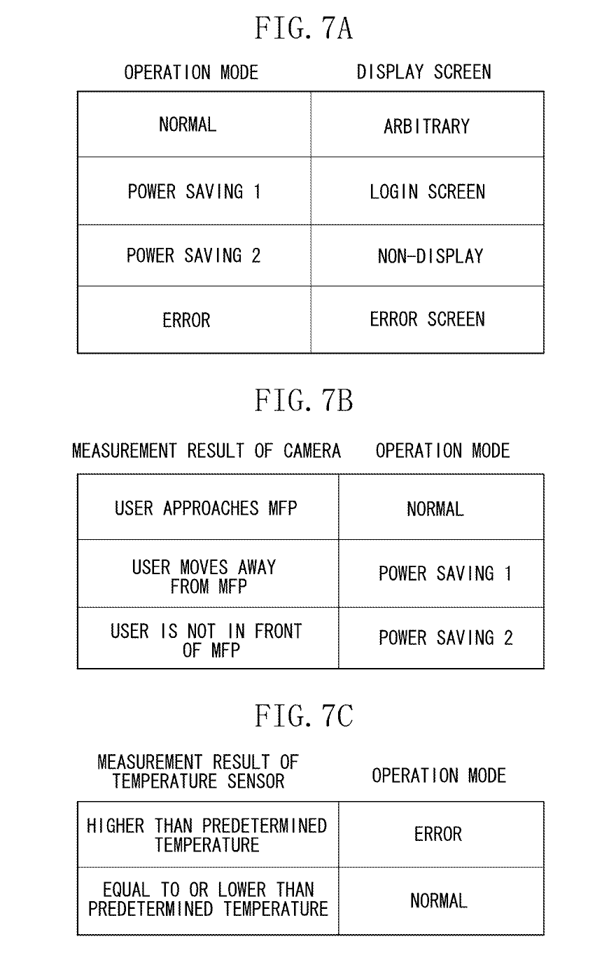

FIGS. 7A, 7B, and 7C each illustrate an example of a management table according to the second exemplary embodiment. The tables illustrated in FIGS. 7A, 7B, and 7C are stored in the storage 108 of the MFP 100.

FIG. 7A is a table illustrating a relationship between a plurality of operation modes of the MFP 100 and types of screens to be displayed. The MFP 100 can operate in one of a plurality of operation modes, and, when certain conditions are satisfied during the operation, changes the operation mode. For example, when a state where the MFP 100 is not operated continues for a predetermined period of time, the MFP 100 changes the operation mode from the normal mode to the “POWER SAVING 1” mode which provides a smaller power consumption than the normal mode. When the state where the MFP 100 is not operated further continues, the MFP 100 changes the operation mode from the “POWER SAVING 1” mode to the “POWER SAVING 2” mode which provides a smaller power consumption than the “POWER SAVING 1” mode.

FIG. 7B is a table illustrating a relationship between results of measurement by the camera 603 of the MFP 100 and the operation modes of the MFP 100. When a result of measurement by the camera 603 is “USER APPROACHES MFP”, the MFP 100 shifts to the normal mode. When a result of measurement by the camera 603 is “USER MOVES AWAY FROM MFP”, the MFP 100 shifts to the “POWER SAVING 1” mode. When a result of measurement by the camera 603 is “USER IS NOT IN FRONT OF MFP”, the MFP 100 shifts to the “POWER SAVING 2” mode which provides a smaller power consumption than the “POWER SAVING 1” mode.

FIG. 7C is a table illustrating a relationship between results of measurement by the temperature sensor 604 of the MFP 100 and the operation modes of the MFP 100. When a result of measurement by the temperature sensor 604 is equal to or lower than a predetermined temperature, the MFP 100 enters the normal mode. On the other hand, when the result is higher than the predetermined temperature, the MFP 100 shifts to the error mode.

### <Flow of Panel Self Refresh Control Based on Operation Mode Change>

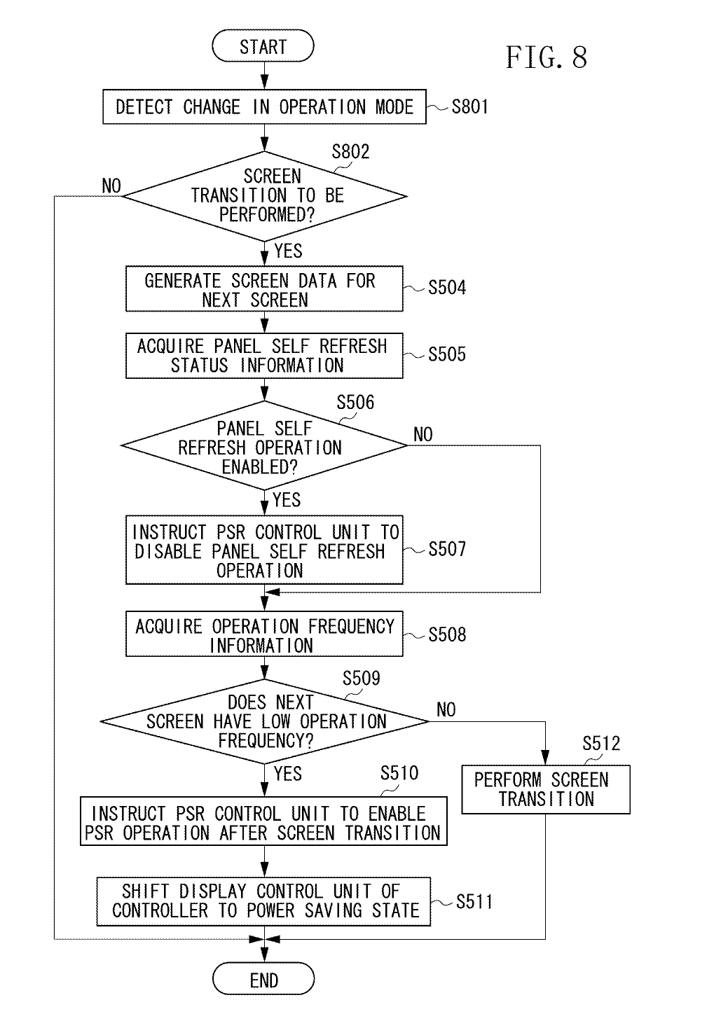

FIG. 8 is a flowchart illustrating panel self refresh control processing according to the second exemplary embodiment. The flowchart illustrated in FIG. 8 is executed by the CPU 101 of the MFP 100. Processing in steps S504 to S512 illustrated in FIG. 8 is similar to the processing in steps S504 to S512 in the flowchart illustrated in FIG. 5, and thus the same step numbers are used.

In step S801, the CPU 101 detects a change in the operation mode of the MFP 100. Although various methods for detecting a change in the operation mode can be considered, it is possible to detect a change in the operation mode, for example, by pre-storing the operation mode information of the MFP 100 in the RAM 115 and checking the information. Although, as described in FIGS. 7B and 7C, an operation mode change is detected based on the result of measurement by the camera 603 or the temperature sensor 604, the configuration is not limited thereto.

In step S802, the CPU 101 determines whether a screen transition is to be performed, based on the operation mode change detected in step S801. When a screen transition is determined to be performed (YES in step S802), the processing proceeds to step S504. On the other hand, when a screen transition is determined not to be performed or a screen display is determined not to be performed (NO in step S802), the processing exits this flowchart. Examples of the mode change accompanied by a screen transition will be described below. In a case where the MFP 100 shifts to the “POWER SAVING 1” mode when the user moves away from the MFP 100 as illustrated in FIG. 7B, the screen changes from the operation screen for the normal mode to the operation screen for the power saving mode. The operation screen also changes when the MFP 100 shifts from the “POWER SAVING 1” mode to the normal mode. No operation screen is displayed in the “POWER SAVING 2” mode. If an error occurs, the screen changes to an error screen.

Processing in steps S504 to S512 is similar to the above-described processing in steps S504 to S512 of the flowchart illustrated in FIG. 5.

As described above, in the second exemplary embodiment, an information processing apparatus having a display device capable of performing the panel self refresh operation determines, in response to a change in the operation mode, whether a screen transition is to be performed, and, based on the result of the determination, performs control to enable or disable the panel self refresh operation. Thus, the power consumption required to display operation screens can be reduced. The MFP 100 according to the second exemplary embodiment may be able to execute not only the flowchart illustrated in FIG. 8 but also the flowchart illustrated FIG. 5. This configuration enables prolonging the panel refresh operation period, and further reducing the power consumption.

An MFP 100 according to a third exemplary embodiment will be described below based on panel self refresh control which is performed in consideration of a relationship between a content of a message and a current login user when the message is automatically displayed on a UI screen.

### <Configuration of MFP According to Third Exemplary Embodiment>

The third exemplary embodiment will be described below. Operations of the MFP 100 according to the third exemplary embodiment (described below) are also applicable to the MFPs 100 according to the first and the second exemplary embodiments. This means that the MFPs 100 according to the first and the second exemplary embodiments can also implement the third exemplary embodiment.

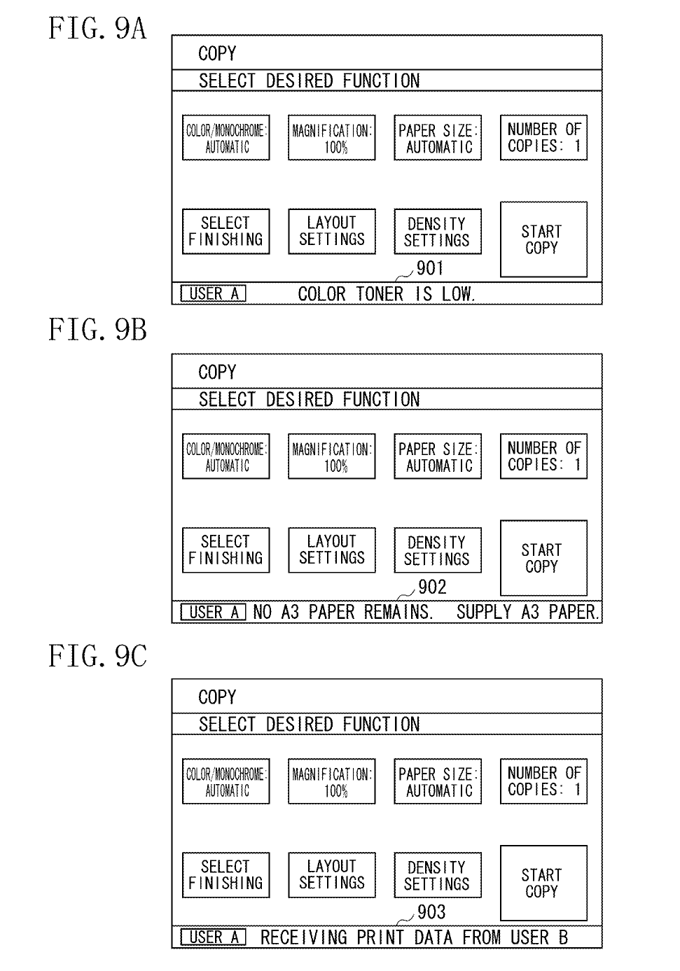

FIGS. 9A, 9B, and 9C each illustrate an example of a copy setting screen displayed on the operation unit 102 of the MFP 100 according to the third exemplary embodiment. The copy setting screen illustrated in FIG. 9A includes a message 901 related to a user A who has logged in the MFP 100 and is currently operating the MFP 100. The copy setting screen illustrated in FIG. 9B includes a message 902 related to the user A who has logged in the MFP 100 and is currently operating the MFP 100. The copy setting screen illustrated in FIG. 9C includes a message 903 related to a user B, not the user A who has logged in the MFP 100 and is currently operating the MFP 100.

### <Flow of Panel Self Refresh Control in Consideration of Relationship Between Message and Login User>

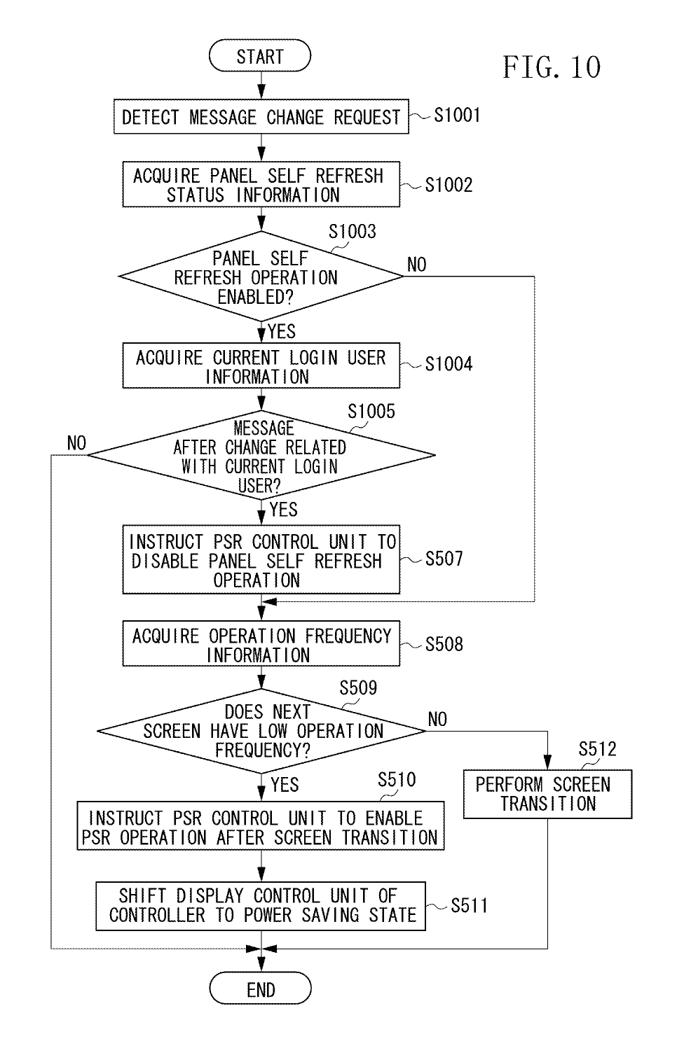

FIG. 10 is a flowchart illustrating panel self refresh control processing according to the third exemplary embodiment. The flowchart is executed by the CPU 101 of the MFP 100. Processing in steps S507 to S512 illustrated in FIG. 10 is similar to the processing in steps S507 to S512 in the flowchart illustrated in FIG. 5, and thus the same step numbers are used.

In step S1001, the CPU 101 detects a request for changing a message. In this case, the request for changing a message is issued by a message management application executed by the CPU 101. The request for automatically changing a message includes the content of a message to be displayed, and information (such as a user ID) indicating which user the message is related to.

In step S1002, the CPU 101 acquires the panel self refresh status information. The panel self refresh status information is similar to the panel self refresh status information according to the first exemplary embodiment described in step S505, and the detailed description thereof will be omitted here.

In step S1003, based on the self refresh status information acquired in step S1002, the CPU 101 determines whether the system is in the panel self refresh state. When the system is determined to be in the self refresh state (YES in step S1003), the processing proceeds to step S1004. On the other hand, when the system is determined to be not in the self refresh state (NO in step S1003), the processing proceeds to step S508.

In step S1004, the CPU 101 acquires the user information of the current login user. As the user information of the current login user, for example, the user ID of the user is stored in the RAM 115. This enables identifying information about the user who is currently operating the MFP 100.

In step S1005, based on the automatic message change request acquired in step S1001 and the user information of the current login user acquired in step S1004, the CPU 101 determines whether the message after change requested in step S101 is related to the current login user. When the message is determined to be related to the current login user (YES in step S1005), the processing proceeds to step S507. On the other hand, when the message is determined to be not related to the current login user (NO in step S1005), the processing exits this flowchart. In this case, since the panel self refresh operation remains enabled, the message is not displayed on the operation unit 102 even if a message change request is issued in step S101. Since the message requested in step S101 is not directed to the current login user, it is not necessary to display the message on the operation unit 102. To reduce the power consumption of the MFP 100, it is more useful to continue the panel self refresh operation without displaying the message.

Processing in steps S507 to S512 is similar to the above-described processing in steps S507 to S512 of the flowchart illustrated in FIG. 5.

As described above, in the third exemplary embodiment, in a case where a message displayed on the screen is automatically updated, the panel self refresh operation is to be canceled and the message is to be updated only when the content of the message is related to the current login user. According to the present exemplary embodiment, when the message is not related to the current login user, the panel self refresh operation is to be maintained without updating the message, thereby allowing the MFP 100 to be in the panel self refresh state for a prolonged period of time. Therefore, the power required to display operation screens can be reduced.

Exemplary embodiments can also be implemented by executing the following processing. More specifically, software (program) for implementing the functions of the above-described exemplary embodiments is supplied to a system or an apparatus via a network or various storage media, and a computer (or a CPU or micro processing unit (MPU), etc.) of the system or the apparatus reads and executes the program.

According to the above-described exemplary embodiments, the panel self refresh operation can be suitably controlled without monitoring whether there is a screen change. Thus, the reduction of power consumption of the apparatus can be facilitated.

Additional embodiments can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2013-272037 filed Dec. 27, 2013, which is hereby incorporated by reference herein in its entirety.

What is claimed is:

1. An information processing apparatus comprising:
a display unit configured to perform a panel self-refresh operation and to display an operation screen;
an identification unit configured to, when a content of the operation screen displayed on the display unit is to be changed, identify a type of operation screen to be displayed after change of the content;
a determination unit configured to, according to the type of operation screen after the change identified by the identification unit, determine whether the display unit is to perform the panel self-refresh operation; and
a control unit configured to, when the determination unit determines the display unit is to perform the panel self-refresh operation, control the display unit to perform the panel self-refresh operation.

2. The information processing apparatus according to claim 1, wherein, depending on whether the type of operation screen after the change identified by the identification unit is a type of operation screen that frequently causes a screen transition, the determination unit determines whether the display unit is to perform the panel self-refresh operation.

3. The information processing apparatus according to claim 2, wherein, when the identification unit identifies that the type of operation screen after the change is the type of operation screen that frequently causes a screen transition, the determination unit determines the display unit is not to perform the panel self-refresh operation.

4. The information processing apparatus according to claim 2, wherein, when the identification unit identifies that the type of operation screen after the change is not the type of operation screen that frequently causes a screen transition, the determination unit determines the display unit is to perform the panel self-refresh operation.

5. The information processing apparatus according to claim 1, wherein, depending on whether the type of operation screen after the change identified by the identification unit is an operation screen that frequently receives an operation from a user, the determination unit determines whether the display unit is to perform the panel self-refresh operation.

6. The information processing apparatus according to claim 5, wherein, when the identification unit identifies that the type of operation screen after the change is the operation screen that frequently receives an operation from the user, the determination unit determines the display unit is not to perform the panel self-refresh operation.

7. The information processing apparatus according to claim 5, wherein, when the identification unit identifies that the type of operation screen after the change is not the operation screen that frequently receives an operation from the user, the determination unit determines the display unit is to perform the panel self-refresh operation.

8. The information processing apparatus according to claim 1, wherein the content of the operation screen displayed on the display unit is changed in response to an operation performed by a user on the operation screen displayed on the display unit.

9. The information processing apparatus according to claim 1, wherein the information processing apparatus is operates in one of a plurality of operation modes, and
wherein the content of the operation screen displayed on the display unit is changed when the operation mode of the information processing apparatus is changed.

10. A method for controlling an information processing apparatus including a display unit configured to perform a panel self-refresh operation and to display an operation screen, the method comprising:
identifying, when a content of the operation screen displayed on the display unit is to be changed, a type of operation screen to be displayed after change of the content;
determining whether the display unit is to perform the panel self-refresh operation according to the identified type of operation screen after the change; and
controlling, when it is determined that the display unit is to perform the panel self-refresh operation, the display unit to perform the panel self-refresh operation.

11. A non-transitory computer-readable storage medium storing computer executable instructions for causing a computer to execute a method for controlling an information processing apparatus including a display unit configured to be capable of performing a panel self-refresh operation and to display an operation screen, the method comprising:
identifying, when a content of the operation screen displayed on the display unit is to be changed, a type of operation screen to be displayed after change of the content;
determining whether the display unit is to perform the panel self-refresh operation according to the identified type of operation screen after the change; and
controlling, when it is determined that the display unit is to perform the panel self-refresh operation, the display unit to perform the panel self-refresh operation.
